(19) United States
(12) Patent Application Publication
(10) Pub. No.: US 2004/0238202 A1
(43) Pub. Date: Dec. 2, 2004

(54) Method of making an inductor with written wire and an inductor made therefrom

(75) Inventor: Walter Mathias, West Henrietta, NY (US)

Correspondence Address: Edward Tracy, Jr., Esq., Simpson & Simpson, PLLC, 5555 Main Street, Williamsville, NY, 14221-5406, US

(73) Assignee: OhmCraft Inc., Honeoye Falls, NY

(21) Appl. No.: 10/453,064

(22) Filed: Jun. 2, 2003

(51) Int. Cl. H02G 3/00

(52) U.S. Cl. 174/100

(57) ABSTRACT

A method for making an inductor comprising writing a conductive coil comprising resistive material onto an outer surface of a substrate, and inductors made therewith is disclosed.

### FIELD OF THE INVENTION

This invention relates to the fabrication of electrical components. More specifically it relates to fabricating electrical components by writing resistive material on a substrate. Even more particularly, it relates to a method for fabrication of inductors by writing resistive material on a substrate and an inductor made therefrom.

### BACKGROUND OF THE INVENTION

The principle of inductance was discovered by Michael Faraday in 1831. He found that a current is induced in a wire loop when a magnet is moved through the loop. The current is generated by the change in the magnetic field within the area enclosed by the wire. The induced current acts to oppose the externally created change in the magnetic field. Joseph Henry also made this discovery at about the same time. The unit of inductance, the Henry, is named after Joseph Henry. (The unit of capacitance, the Faraday, is named after Michael Faraday.)

As is known in the art, an inductor is a circuit element that uses the principle of inductance to store energy in a magnetic field. A typical inductor is made by coiling a wire around a substrate, as shown in U.S. Pat. No. 4,064,472 (Gunewardena et al.). However, it is difficult to manufacture an inductor comprising a physical wire in an efficient manner. In addition, it is difficult to fabricate inductors having low tolerances if the inductors are made with wires wound around a substrate, as the inductance of the device depends on the geometry of the device. Any difference in the wire or winding between inductors will cause a difference in the inductance generated by the device.

The writing of resistive ink onto a substrate has been used to make resistors of low tolerance, as disclosed by the applicant in U.S. Pat. No. 5,548,268 (Collins). However, this more accurate means for producing circuit components has not been used to create inductors.

Clearly, then, there is a longfelt need for an inductor that has superior electrical properties and tolerances in comparison to an inductor comprising a coiled wire.

### SUMMARY OF THE INVENTION

The present invention broadly comprises a method for making an inductor comprising writing a conductive coil comprising resistive material onto an outer surface of a substrate, and an inductor made with the method.

A general object of the present invention is to provide an inductor with tolerances superior to an inductor comprising a coiled wire.

It is another object of the present invention to provide an economical method of making an inductor with tolerances superior to an inductor comprising a coiled wire.

These and other objects, features and advantages of the present invention will become readily apparent to those having ordinary skill in the art upon a reading of the following detailed description of the invention in view of the drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of the preferred embodiment of the present invention;

FIG. 1A is a fragmentary enlarged view of section 1A-1A of the preferred embodiment of the present invention, as illustrated in FIG. 1;

FIG. 2 is a schematic view of the preferred embodiment of the present invention;

FIG. 3 is a perspective view of a second embodiment of the present invention;

FIG. 4 is a perspective view of a third embodiment of the present invention;

FIG. 5 is a perspective view of an apparatus for making an inductor of the present invention;

FIG. 6 is a view of a substrate cut into three pieces to form three inductors, according to the present invention; and,

FIG. 7 is a perspective view of a fourth embodiment of the present invention.

### DETAILED DESCRIPTION OF THE PREFERRED EMBODIMENT

It should be appreciated that in the detailed description of the invention which follows that like reference numbers on different drawing views are intended to identify identical structural elements of the invention in the respective views.

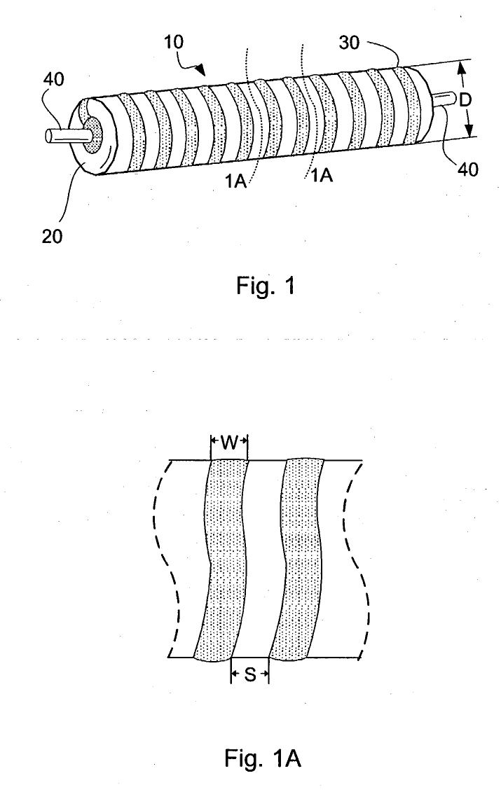

The preferred embodiment of the present invention is shown in perspective in FIG. 1 and designated 10. Article of manufacture 10 is an inductor comprising substrate 20, continuous helical conducting coil 30, and leads 40. Substrate 20 comprises a non-conducting surface. In a preferred embodiment, substrate 20 is ferrite and/or a ceramic material. However, substrates of cardboard, plastic, Mylar®, fiberglass, polymer, or any other substrate known in the art may be used, and these modifications are intended to be within the spirit and scope of the invention as claimed. FIG. 1 shows that in a preferred embodiment, substrate 20 has a cylindrical shape, with a cross section of diameter D.

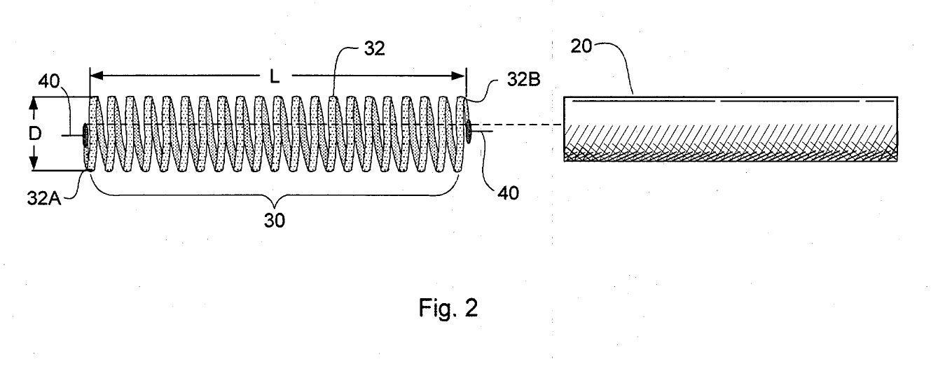

As shown in FIG. 2, conductive coil 30 comprises a plurality of loops 32. As shown in the close up view of FIG. 1A, each loop has a width W, and is a distance S away from each adjacent loop. The coil is made in one embodiment by distributing resistive ink onto the surface of the substrate. In a preferred embodiment, writing the resistive ink comprises dispensing a pressurized liquid through a nozzle as disclosed in U.S. Pat. No. 5,521,576 (Collins) and U.S. Pat. No. 4,485,387 (Drumheller), incorporated by reference herein. Resistive ink may comprise any conductive material. In a preferred embodiment, conducting coil 30 comprises gold, silver, or copper. N loops are deposited along the length L of the substrate. By creating the conductive coil with resistive ink, the geometry of the coil can be tightly controlled. The electrical properties of each inductor have much lower tolerances than inductors made with coiled wires. Thus, the present invention provides a method for making inductors having superior tolerances to a coiled wire inductor.

It should be readily apparent to one skilled in the art that other means of writing resistive material on a substrate are possible, such as screen printing, thin film deposition, electroplating, electroless plating, and any other method known in the art. These modifications are within the spirit and scope of the invention as claimed.

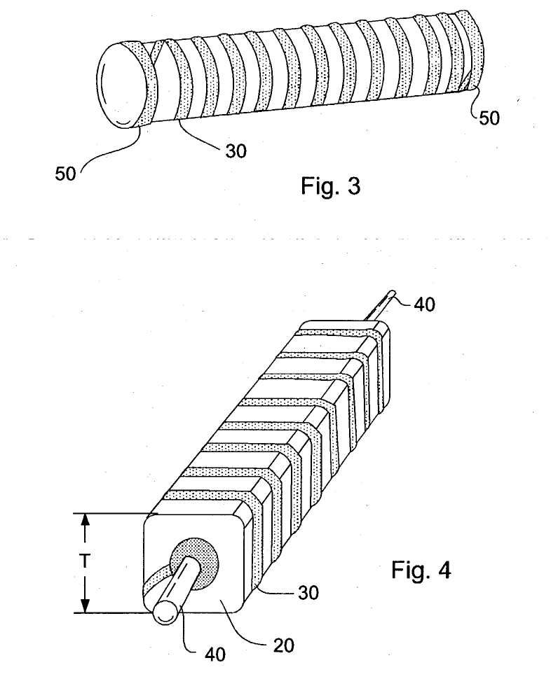

FIG. 2 shows leads 40 connected to the first and last loops 32A and 32B, respectively, of coil 30. FIG. 3 shows a second embodiment comprising conductive rings 50 connected to the first and last loops of conductive coil 30. It should be readily apparent to one skilled in the art that these and other means for electrically connecting a circuit component are possible, and these modifications are within the spirit and scope of the invention as claimed.

FIG. 4 shows a third embodiment wherein substrate 20 has a substantially square cross-section with each side having a length T. It should be readily apparent to one skilled in the art that the present invention can be practiced with substrates having cross sections of any shape, and these modifications are intended to be within the spirit and scope of the invention as claimed.

The inductance of an element having a coil of conductive material around a substrate is:

$$H = \frac{4 π {N}^{2} A μ}{1 \times {10}^{7} L}$$

wherein H is the inductance of the device, N is the number of loops, A is the area of each loop, μ is the permeability of the substrate, and L is the length of the coil.

For the configuration shown in FIG. 1, the inductance is:

$$H = \frac{{π}^{2} {N}^{2} {D}^{2} μ}{1 \times {10}^{7} L}$$

since the cross sectional area of a circle is πD²/4.

For the configuration shown in FIG. 4, the inductance is:

$$H = \frac{4 π {N}^{2} {T}^{2} μ}{1 \times {10}^{7} L}$$

since the cross sectional area of a square is T². Thus, an element with any desired inductance may be designed by controlling the properties of the substrate 20 and the number of loops 32.

As a non-limiting example, the applicant has made an inductor by writing a 0.5 cm length (L) of gold loops having a width (W) of 0.0508 millimeters (mm) (0.002 inches) on a ferrite core having a diameter (D) of 0.5 mm. The distance between the loops (S) is 0.15 mm. The coil has 2,500 loops (N). The ferrite core has a permeability (μ) of approximately 2,000, leading to an inductance (H) of approximately 0.003 Henries.

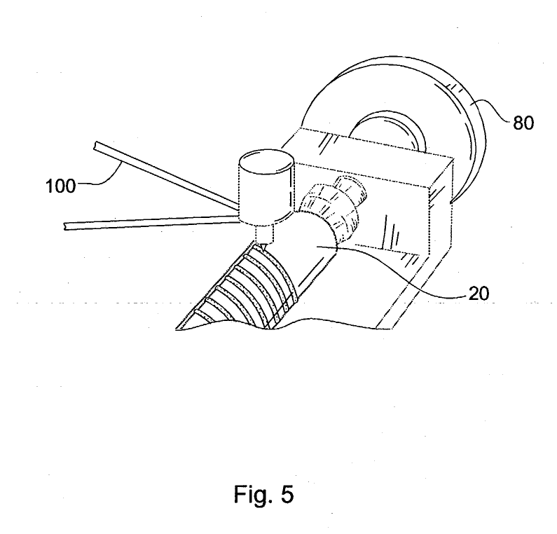

FIG. 5 is a perspective view of the preferred means for making the preferred embodiment. Machine 100 is an inking system for writing resistive ink as disclosed in U.S. Pat. No. 4,485,387 (Drumheller), incorporated by reference herein. Substrate 20 is held by lathe 80. Lathe 80 rotates at a controlled rate to ensure the desired thickness of ink is distributed onto the surface of the substrate 20. Lathe 80 also continuously moves substrate 20 in an axial direction to distribute the ink along the axis of substrate 20, forming continuous helical coil 30. When the desired number of loops is deposited, substrate 20 is removed from lathe 80. It should be readily apparent to one skilled in the art that other machines could be used to practice the method of the present invention. These modifications are within the spirit and scope of the invention as claimed.

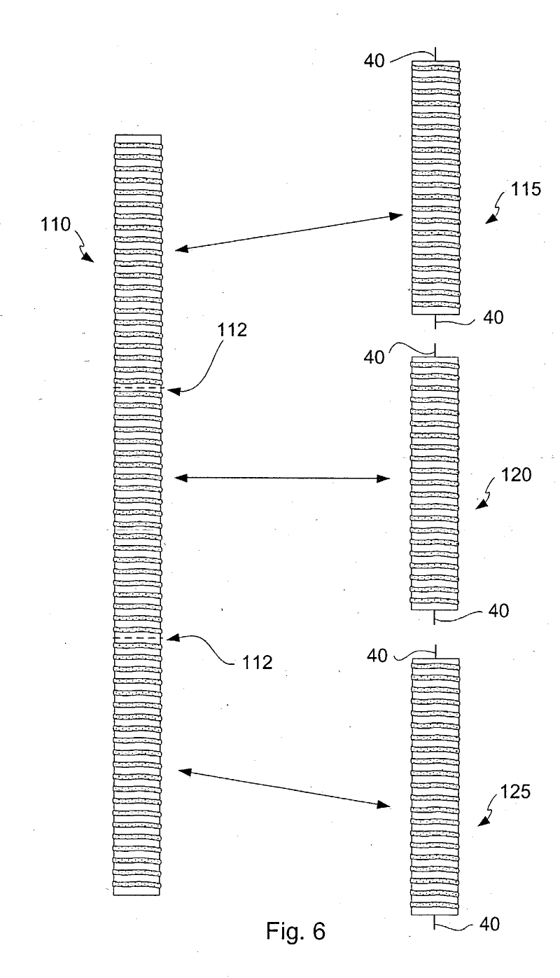

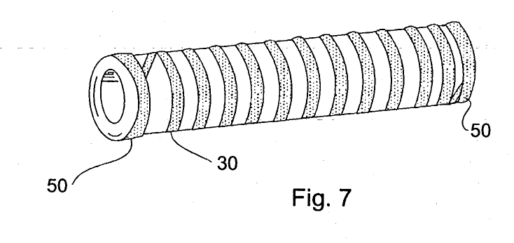

To complete the manufacturing process, means to connect the element into an electrical circuit are attached to the ends of coil 30, or the substrate is cut into multiple pieces along the length of the substrate. In the latter case, means to connect the element into an electrical circuit are attached to each end of the smaller pieces, making multiple inductors from a single substrate. An example is shown in FIG. 6 where article of manufacture 110 is cut into three pieces to form inductors 115, 120, and 125.

FIG. 7 illustrates a fourth embodiment comprising a hollow substrate. A hollow substrate will likely have a lower permeability than a solid substrate comprising the same material. Thus, an inductor made with a hollow substrate will likely have a lower inductance than an inductor made with a solid substrate comprising the same material. Inductors made with both solid and hollow substrates are within the spirit and scope of the invention as claimed.

FIGS. 1-6 show coils having constant widths W and separation distances S throughout the entire coil. However, it should be readily apparent to one skilled in the art that inductors can be made according to the present invention with varying coil widths W and separation distances S, and these modifications are intended to be within the spirit and scope of the invention as claimed. Further, FIGS. 1-3 and 5-7 show coils in the shape of a helix. However, it should be readily apparent to one skilled in the art that inductors can be made according to the present invention with different coil shapes, and these modifications are intended to be within the spirit and scope of the invention as claimed. (As used in the specification and claims of the present application, a helix is a mathematical curve that lies on a cylinder and makes a constant angle with the straight lines lying in the cylinder.)

Thus, it is seen that the objects of the present invention are efficiently obtained, although modifications and changes to the invention should be readily apparent to those having ordinary skill in the art, and these modifications are intended to be within the spirit and scope of the invention as claimed.

1. A method for making an inductor comprising:
writing a conductive coil comprising resistive material onto an outer surface of a substrate.

2. The method recited in claim 1 wherein said substrate comprises ferrite.

3. The method recited in claim 1 wherein said substrate comprises ceramic.

4. The method recited in claim 1 wherein said resistive material comprises gold.

5. The method recited in claim 1 wherein said resistive material comprises copper.

6. The method recited in claim 1 wherein said resistive material comprises silver.

7. The method recited in claim 1 wherein said substrate is a substantially cylindrical solid.

8. The method recited in claim 1 wherein said substrate is substantially a rectangular solid.

9. The method recited in claim 1 wherein said substrate is hollow.

10. The method recited in claim 1 wherein said writing comprises screen printing.

11. The method recited in claim 1 wherein said writing comprises thin film deposition.

12. The method recited in claim 1 wherein said writing comprises electroplating.

13. The method recited in claim 1 wherein said writing comprises electroless plating.

14. The method recited in claim 1 wherein said writing comprises dispensing a pressurized resistive ink through a nozzle.

15. An article of manufacture comprising:
a substrate having a non-conductive outer surface;
a conductive coil comprising resistive material written onto said outer surface of said substrate; and,
terminals electrically connected to said conductive coil.

16. The article of manufacture recited in claim 15 wherein said substrate comprises ferrite.

17. The article of manufacture recited in claim 15 wherein said substrate comprises ceramic.

18. The article of manufacture recited in claim 15 wherein said resistive material comprises metal.

19. The article of manufacture recited in claim 15 wherein said resistive material comprises gold.

20. The article of manufacture recited in claim 15 wherein said resistive material comprises copper.

21. The article of manufacture recited in claim 15 wherein said resistive material comprises silver.

22. The article of manufacture recited in claim 15 wherein said substrate is a substantially cylindrical solid.

23. The article of manufacture recited in claim 15 wherein said substrate is shaped like a rectangular solid.

24. The article of manufacture recited in claim 15 wherein said substrate is hollow.

25. The article of manufacture recited in claim 15 wherein said coil is shaped like a helix.

26. The article of manufacture recited in claim 15 wherein said terminals comprise conductive rings.

27. The article of manufacture recited in claim 15 wherein said terminals comprise conductive leads.

28. The article of manufacture recited in claim 15, wherein said substrate is selected from the group consisting of ferrite, a ceramic material, a cardboard, a plastic, a fiberglass, and a polymer.

29. The article of manufacture recited in claim 15, wherein said resistive material is selected from the group consisting of gold, silver and copper.

30. The article of manufacture recited in claim 15, wherein said writing of said resistive material onto said outer surface is selected from the group consisting of screen printing, thin film deposition, electroplating, and electroless plating.

31. An article of manufacture comprising:
a substrate having a non-conductive outer surface;
a conductive coil comprising a plurality of loops of a resistive material written onto said outer surface of said substrate; and,
terminals electrically connected to said conductive coil.

32. An article of manufacture comprising:
a substrate having a non-conductive outer surface;
a conductive coil comprising at least one loop of a resistive material written onto said outer surface of said substrate; and,
at least one conductive lead or ring electrically connected to said at least one loop of said conductive coil at a terminal end of said substrate.

33. The article of manufacture recited in claim 31, wherein said substrate is selected from the group consisting of ferrite, a ceramic material, a cardboard, a plastic, a fiberglass, and a polymer.

34. The article of manufacture recited in claim 31, wherein said resistive material is selected from the group consisting of gold, silver and copper.

35. The article of manufacture recited in claim 32, wherein said substrate is selected from the group consisting of ferrite, a ceramic material, a cardboard, a plastic, a fiberglass, and a polymer.

36. The article of manufacture recited in claim 32, wherein said resistive material is selected from the group consisting of gold, silver and copper.
